(19) United States
(12) Patent Application Publication
(10) Pub. No.: US 2014/0289061 A1
(43) Pub. Date: Sep. 25, 2014

(54) POINT-OF-SALE TERMINAL BASED MOBILE ELECTRONIC WALLET REGISTRATION, AUTHORIZATION AND SETTLEMENT

(71) Applicant: Mony S. Zenou, Great Neck, NY (US)

(72) Inventor: Mony S. Zenou, Great Neck, NY (US)

(73) Assignee: I-POS SYSTEMS LLC, Manhasset, NY (US)

(21) Appl. No.: 13/898,630

(22) Filed: May 21, 2013

Related U.S. Application Data
(60) Provisional application No. 61/804,691, filed on Mar. 24, 2013.

(51) Int. Cl. G06Q 20/18; G06Q 20/36

(52) U.S. Cl. CPC G06Q 20/18; G06Q 20/36
USPC 705/21

(57) ABSTRACT

Methods for conducting a transaction of a mobile electronic wallet (EW) with a merchant electronic point-of sale (POS) terminal include use of the POS terminal to provide authorization for the transaction directly to an EW terminal server (TS) without involvement of a transaction gateway. The EW-TS receives a transaction request from an authenticated EW application in a mobile device and provides an approval for stored EW-TS card data delivered to the POS terminal The POS terminal authorizes the transaction and submits the authorization request to a host processor. In some embodiments, the POS terminal also enrolls an EW in a mobile EW program. In some embodiments, the POS terminal also settles the transaction. In some embodiments, an EW sends checking account information to be proceessed by check services of the POS terminal. In some embodiments, additional consumer payment data is captured during the EW enrollment.

### CROSS REFERENCE TO RELATED APPLICATIONS

This application claims the benefit of U.S. provisional patent application No. 61/804691 filed Mar. 24, 2013 and having the same title, which is incorporated herein by reference in its entirety.

### FIELD

Embodiments disclosed herein relate in general to commerce using an electronic wallet (EW) and a merchant electronic point-of-sale (POS) terminal with or without peripheral devices, and more particularly to the use of mobile devices which carry an EW to register, subscribe, transmit payment and related data and settle transactions through or with a POS terminal.

### BACKGROUND

There are three known types of Electronic Wallets (EWs) with three distinctive approaches to provide consumers with payment capabilities: (1) bank based EWs targeted to card issuers such as Visa, MC, AMEX or Discover, which issue their own cards to be included in EWs, usually to existing card holders; (2) consumer based EWs such as Google Wallet or ISIS, which offer to store an issuer card in a “mobile EW”, i.e. in a personal mobile device enabled with wireless means such as Wi-Fi, Bluetooth and GPRS or CDMA, for example a cell phone, a PDA or a portable tablet computer. Such a mobile EW can store various cards or payment forms electronically. In the following description, a mobile EW may sometimes be referred to simply as “EW”, with the understanding that the reference is to an EW application or “EW App” in a mobile device. In some cases, an E-commerce—Internet based payment service such as PayPal may issue a physical (e.g. plastic) card for its online account members and associate it with an existing issuer, In Pay Pal's case, such cards or the original PayPal account may also be stored in a mobile EW; and (3) merchant-centric EWs designed predominantly to increase patron loyalty and to enable easy payment via EW for a particular store, or, in some cases, to use an affinity program for recognition and acceptance with loyalty privileges in affiliate or other stores. Usually, such inter-location affinity or loyalty is managed by an EW transaction server (also referred to simply as “EW-TS” or “TS”), which manages, stores, and keeps consumer card records and transaction data securely. Electronic wallets may also store card data in the mobile devices by adding a secure authentication between them and a specific POS system. For example, in the “TabbedOut” restaurant mobile application, encrypted card data stored in an EW is authenticated by a restaurant POS system named “MICROS”. When a transaction is conducted directly between the EW and MICROS, card data is decrypted and used to submit a payment to the card association.

Once a card holder decides to join a particular EW, his/her card data is stored in a respective particular EW-TS. Credit, debit, prepaid, gift or loyalty card data are stored in a secure Payment Card Industry Data Security Standard (PCI-DSS) facility. The stored card information is used to authorize a transaction after proper authentication with the EW-TS. The communication between the EW and the POS system may be RFID enabled (one way communication) or peer-to-peer (two way communication) using for example near field communication (NFC) readers installed on both POS terminals and cash registers. The communication between the EW and the POS terminal or between the EW and the EW-TS must use advanced security tools such as specific encrypted authentication data, tokenization, password identification, or a combination thereof. In this case, authentication is not conducted between the EW and the EW-TS, but directly between the EW App and the POS system. Once authenticated, a secure transaction will take place between the EW-TS and the EW. The EW will be identified, associated with secure card data located in the EW-TS and, after authentication, consumer card data will be authorized to submit payment information to card association issuers. The issuers will provide an approval or a decline response, and an appropriate message will be returned to the mobile device. Consequently, the EW-TS needs to use a transaction gateway to connect to host processors for authorizations. Such transaction gateways increase transactions costs and require the EW-TS to update the POS terminal after the transaction authorization is obtained. To clarify, all currently known mobile EW transactions conducted through an EW-TS use a Web (or Internet) based transaction gateway.

None of the known systems and methods that use a PCI DSS location to store card data uses a POS terminal to conduct the actual authorization to the card issuers. Similarly, no known methods use a POS terminal to register consumer card data at the POS terminal while authorizing a card, to conduct a special registration process, to capture additional relevant payment data, such as an electronic signature, or to enroll a new member to an EW.

There is therefore a need for, and it would be advantageous to have, methods and systems for conducting transactions using an EW and a POS terminal that do not suffer from the disadvantages of known methods and systems, In particular, it would be advantageous to have methods and systems for conducting transactions using an EW and a POS terminal that do not need to use a transaction gateway and that allow a POS terminal to: (1) authorize and check rewards eligibility in real time without any other supporting system or card, (2) settle a transaction and (3) enroll consumers and consumer payment data through a new EW into an EW program.

### SUMMARY

The following terms and definitions are used in the description:

“Payment instrument” refers to any type of instrument that can be used to pay for a transaction, including consumer credit, debit, gift and loyalty cards as well as checks.

“Payment instrument data” refers to data identifying, or specific to, a payment instrument.

“Payment instrument issuers” refers to credit card issuers, debit card issuers, other type of card issuers and banks (holding checking accounts).

“Transaction data” refers to data captured from a payment instrument. The transaction data is sent from the POS terminal to the EW-TS and to host processors for authorization, and is stored in a either truncated or secured format in the EW-TS for payment transaction, loyalty tracking, rewards and reporting purposes.

“Card data” refers to credit or debit card data, magnetic strip or RFID reader, smart card or “subscriber identity module (“SIM”) data or “magnetic ink character recognition (“MICR”) data (for checks). The card data is secured in an encrypted format at the EW-TS after the registration from the POS terminal or a subsequent addition to a consumer EW, and is used upon a call from a POS terminal to conduct a payment transaction.

“Consumer payment data” refers to supporting documents or images used to identify a consumer authenticity at the transaction time, for example a real signature, an electronic signature, a biometric signature, a photograph, etc.

Embodiments disclosed herein teach utilization of a POS terminal for authorizing a transaction with a card association by sending a request for authorization to a card issuer after tokenization and authentication between a mobile EW and the EW-TS are completed. Tokenization and/or authentication are performed between the mobile EW and the EW-TS. Card data and, optionally, consumer payment data (such as an electronic signature) stored in the EW-TS, are then sent (e.g. via a secure connection such as SSL) from the EW-TS to the POS terminal The POS terminal then authorizes the transaction. In contrast with known methods, the EW-TS receives a message of approval from the POS terminal and not from a transaction gateway. This eliminates the added costs of gateway-based payment processing and removes the added complexity in the acceptance of a mobile EW transaction process.

Embodiments disclosed herein also teach utilization of a POS terminal for registration of a mobile EW, replacing the current need for a transaction gateway. Embodiments disclosed herein further teach utilization of a POS terminal for a transaction settlement (submission of the authorization approval for clearance and payment by the host processors of EW transactions). The POS terminal also reduces (and in some cases eliminates) the need for computer- or phone-based registration of consumer card data to the EW-TS and EW, by using the initial transaction data generated by swiping a card through (or contacting) the POS terminal to register a particular card to a “card on file” record in the EW-TS, or by adding an additional card to an existing EW and EW-TS via the same procedure. Certain additional data fields such as “consumer photo”, “fingerprint”, “electronic imprint of signature”, etc., may prompt for additional EW registration as either a requirement or optionally, with the main purpose to: (1) add to identification instruments of the purchasing consumer, or (2) to enable such data to be appended to a customary POS terminal transaction, i.e. provide a digital signature to a POS terminal that does not have a special signature capture device attached thereto. A transaction with additional consumer payment data can be performed either through the POS terminal or through the phone or the Internet.

In various embodiments disclosed herein, a POS terminal, verified by its location, a number, a unique identification such as (but not limited to) a Quick Response Bar Code (“QC”) generated by the POS terminal or attached to it or by any other means as needed; (1) registers a new payment instrument to EW-TS programs; (2) allows an end user to set an initial personal identification number (PIN) for accessing a new EW account via a first transaction with a new card, a check reader or consumer payment data such as signature capture at the POS terminal; (3) sends a new membership (enrollment) request to the EW-TS and, subsequently; (4) on the initial registration transaction, processes the payment instrument to complete the sale from the POS terminal or through the EW-TS In a future transaction by a consumer at the merchant location using the POS terminal, the consumer uses his/her EW to send a request to the EW-TS and the EW-TS sends to the POS terminal the secured payment data of payment instruments registered to a particular EW via SSL or via any other Internet secured communication protocol. The POS terminal enables authorization of the sales amount with the payment instrument received from the EW-TS. After the authorization, the POS terminal updates the EW-TS, which in turn updates the mobile EW with the transaction results. Additionally, the EW-TS can verify eligibility for rewards, provide free service, product, discount and other promotion in real time, and return a confirmation message to the POS terminal to reflect and adjust a sales amount. Moreover, after registration of a payment instrument to the EW-TS via the POS terminal, the EW-TS can be used for transactions conducted not only by the EW application but also via more common payment methods (not through a POS terminal) such as the phone or the Internet.

All transaction reports for the merchant are stored in a POS terminal database (“DB”). Consumers may check their balances and transaction history on either the EW or the EW-TS. Similarly, the settlement is performed by the POS terminal and not by the EW-TS. The merchant may also optionally view transaction summaries, history and details on both the POS terminal and the EW-TS.

In some embodiments, if a payment option is “checking account”, a customer account is “captured” by scanning a check on the POS terminal or a peripheral device connected thereto. The transaction then follows the same process of asking for a cell phone number and password, confirming the account in the EW, confirming with a PIN through login into the EW-TS and enabling a same or subsequent transaction to use the “checking account” payment instrument via the EW. The POS terminal then sends an authorization request with checking account data stored in the EW-TS for authorization to process the charge.

In some embodiments, a “signature capture” program may be created on a smart phone and stored on the EW or the EW-TS. The signature can be captured either during the registration process to an EW-TS or as a stand alone service for the sole purpose of supporting POS terminal transactions performed by the POS terminal without an EW-TS storing payment instruments, or directly from a mobile device. The signature can be stored in either the EW or the EW-TS and serves as additional payment data that may be used independently from the payment instrument used in a transaction. For example, the signature can be called from the EW-TS and used in a paperless transaction and a POS transaction receipt is transmitted to a consumer e-mail address. This provides a “green” POS terminal By enabling electronic data on a mobile application with the consumer, a merchant operating a POS terminal can collect consumer data, track purchasing data and enable cell phone-based loyalty and rewards programs.

In some embodiments, a real time loyalty program is created, driven only by the POS terminal and the EW-TS without any physical cards or a gift processor. The EW-TS checks consumer rewards eligibility on every transaction performed and provides a discounted transaction free purchase of another reward while conducting a payment from an EW to the EW-TS.

Conducting a transaction between the EW and the EW-TS through a POS terminal may minimize merchant fees. For example, a restaurant transaction (combining gross authorization amount and actual tip amount into a total amount) is normally sent in two separate transactions and charged more than a single sale transaction. As taught herein, a mobile EW can be programmed to separate the two (gross authorization and tip) amounts while the POS terminal will transmit it as one, in a single transaction flow.

In an embodiment there is provided a method for conducting a transaction between an EW and a merchant POS terminal, the EW associated with an EW App included in a mobile device, the method comprising the steps of: by an EW-TS, receiving a transaction request from a particular EW and from an authenticated POS terminal for a sales amount; sending respective EW-associated payment instrument data back to the POS terminal, and receiving from the POS terminal authorization approval for the transaction, wherein the authorization approval is received directly from the POS terminal without use of a transaction gateway.

In an embodiment there is provided a method for conducting a transaction between an EW and a merchant POS terminal, the EW associated with an EW App included in a mobile device, the method comprising the steps of: by an EW-TS, receiving a transaction request with a sales amount, cell phone number and password from a POS terminal, sending a selected payment instrument to the POS terminal, and receiving from the POS terminal authorization approval for the transaction, wherein the authorization approval is received directly from the POS terminal without use of a transaction gateway.

In an embodiment there is provided a method for conducting a transaction between an EW and a merchant POS terminal, the EW associated with an EW App included in a mobile device, the method comprising the steps of: by a POS terminal, sending a transaction request obtained from a particular EW to an electronic wallet terminal server (EW-TS), the transaction request including a sales amount and a request for supporting payment instrument data, receiving from the EW-TS respective EW-associated payment instrument, and authorizing the transaction, wherein the authorization is provided directly from the POS terminal to the EW-TS without use of a transaction gateway.

### BRIEF DESCRIPTION OF THE DRAWINGS

Aspects, embodiments and features disclosed herein will become apparent from the following detailed description when considered in conjunction with the accompanying drawings, in which:

FIG. 1A shows a flow chart of an embodiment of a method disclosed herein that allows EW payment with POS terminal authorization;

FIG. 1B shows a flow chart of another embodiment of a method disclosed herein that allows EW payment with POS terminal authorization;

FIG. 1C shows details of the method embodiments in FIGS. 1A and 1B;

FIG. 1D shows schematically in a block diagram an embodiment of a system disclosed herein that allows EW payment with POS terminal authorization;

FIG. 2 shows in a flow chart the exemplary use of a mobile device which includes an EW for a “pay-at-the table” transaction with POS terminal authorization in a restaurant;

FIG. 3 shows in a flow chart an exemplary consumer enrollment procedure using a mobile EW and a POS terminal;

FIG. 4 shows in a flow chart a known exemplary transaction flow between a mobile EW and a POS system and using a payment gateway;

FIG. 5 shows an exemplary payment processing using a POS terminal according to a method disclosed herein.

### DETAILED DESCRIPTION

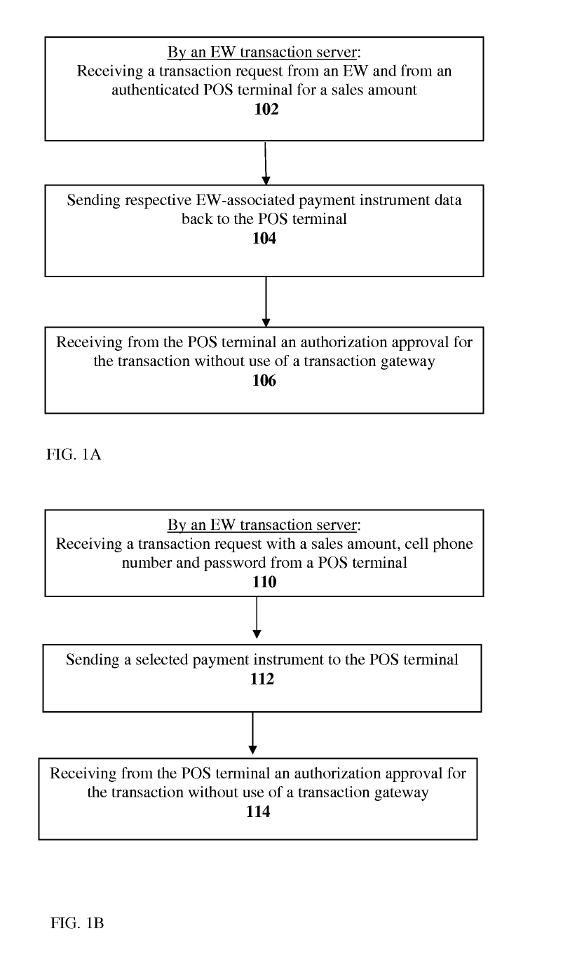

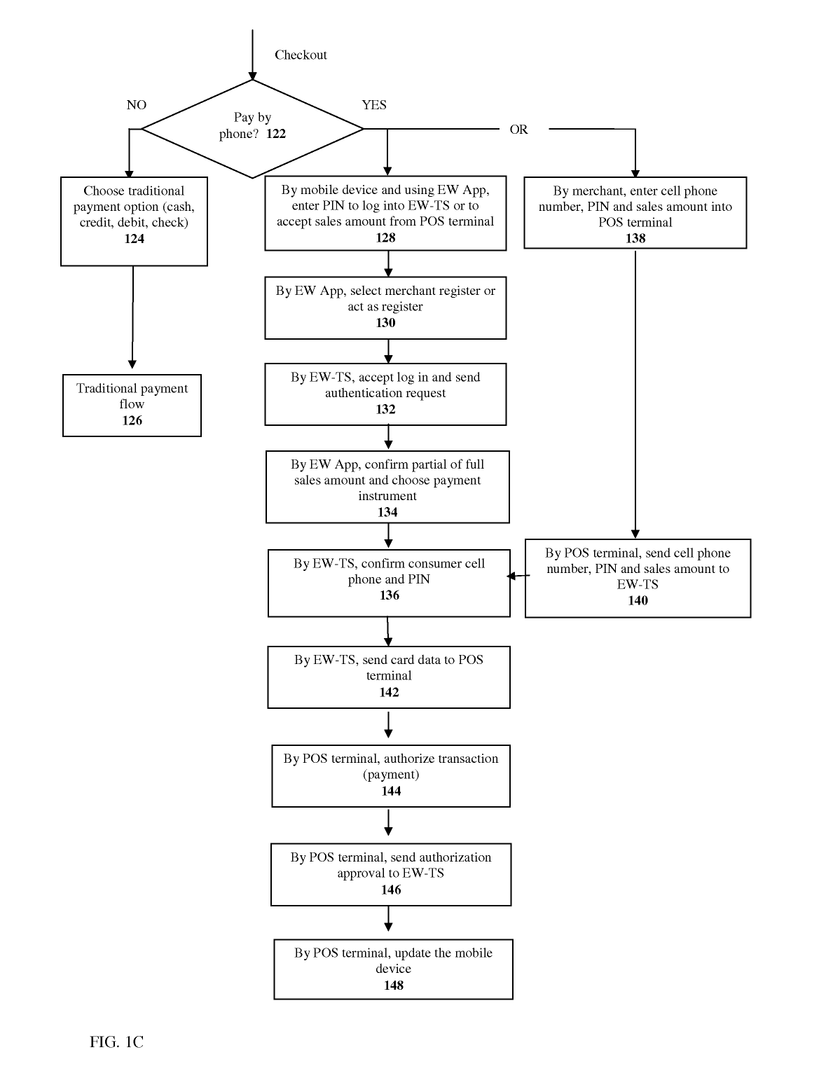

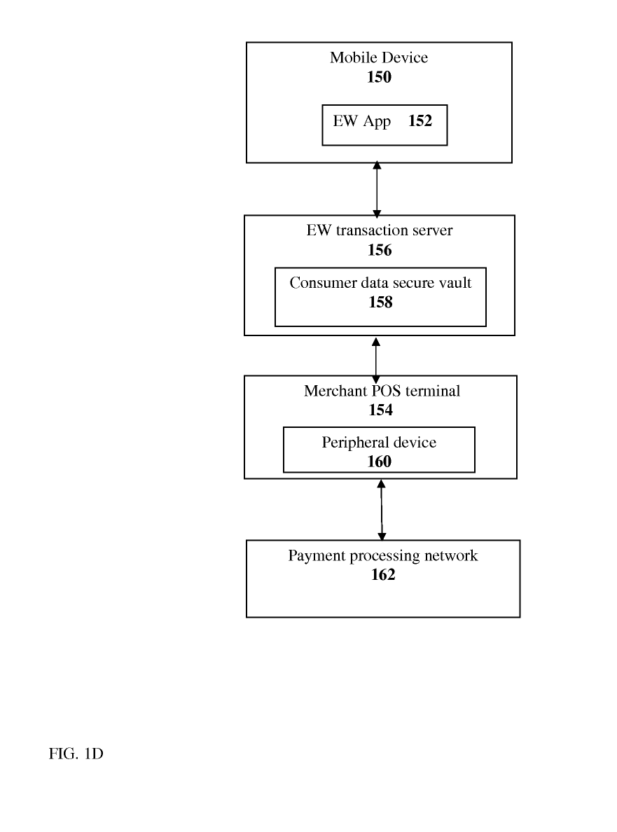

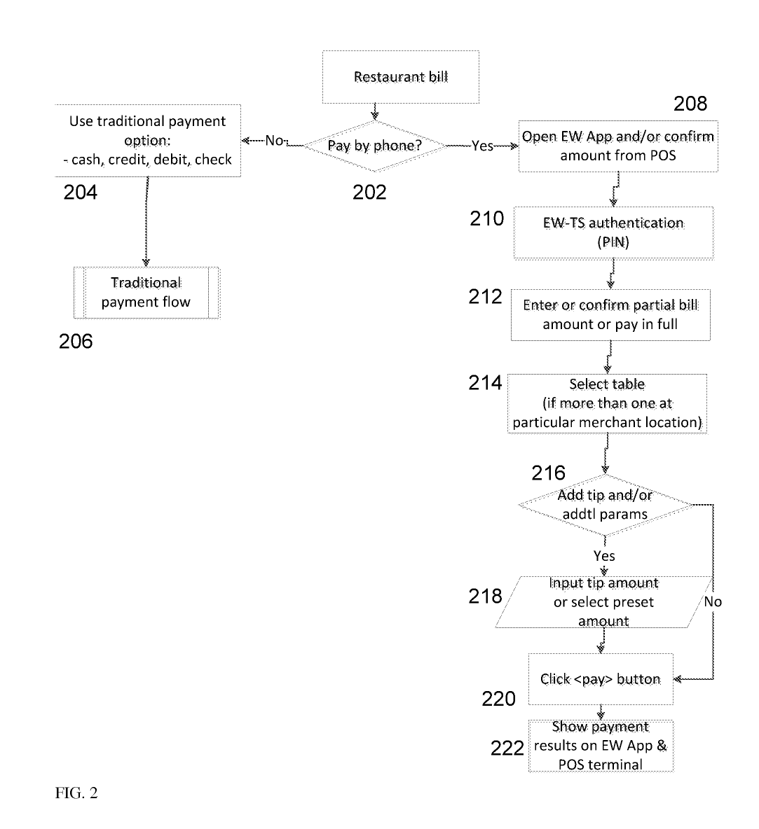

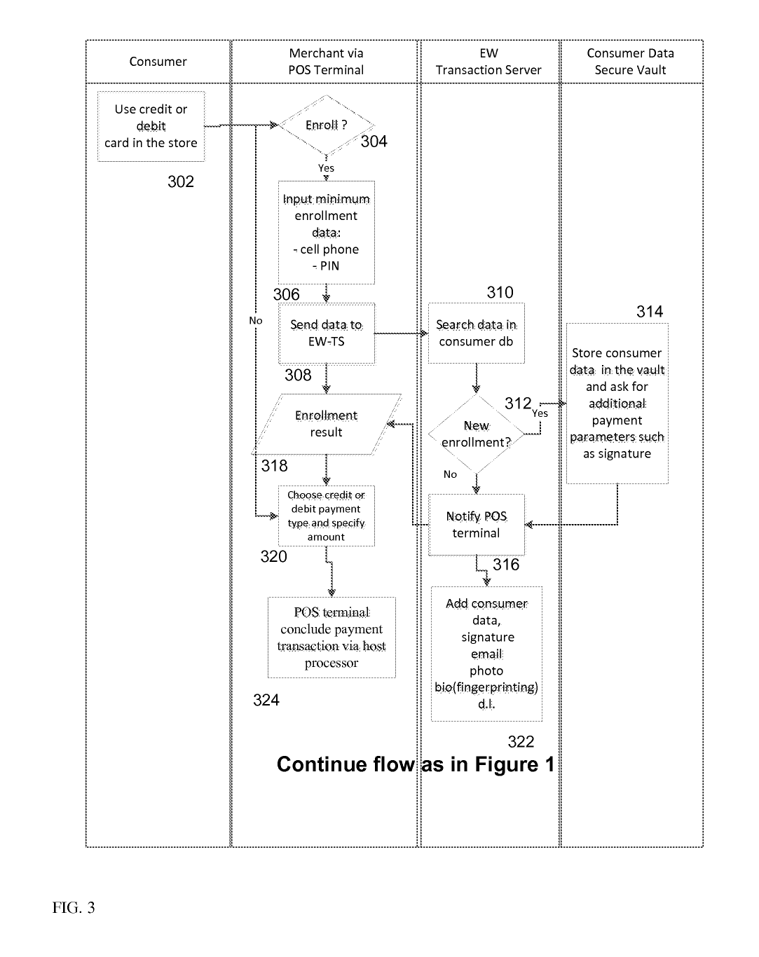

FIG. 1A shows a flow chart of an embodiment of a method disclosed herein that allows EW payment with POS terminal authorization. The method allows conducting a transaction between an EW and a merchant POS terminal. The EW has an EW App associated therewith and included in a mobile device (e.g. cell phone). An EW-TS receives a transaction request from an EW and from an authenticated POS terminal for a sales amount in step 102, sends respective EW-associated payment instrument data back to the POS terminal in step 104, and receives from the POS terminal an authorization approval for the transaction in step 106. Advantageously, the authorization approval is transmitted directly from the POS terminal to the EW-TS without use of a transaction gateway.

FIG. 1B shows a flow chart of another embodiment of a method disclosed herein that allows EW payment with POS terminal authorization. Similar to the embodiment in FIG. 1A, in this this embodiment too the authorization approval is transmitted directly from a POS terminal to the EW-TS without use of a transaction gateway. The EW-TS receives a transaction request with a sales amount, cell phone number and password from the POS terminal in step 110, sends a selected payment instrument to the POS terminal in step 112, and receives from the POS terminal an authorization approval for the transaction without use of a transaction gateway in step 114. As in the embodiment in FIG. 1A, the authorization approval is transmitted directly from the POS terminal to the EW-TS without use of a transaction gateway.

FIG. 1C shows details of the method embodiments in FIGS. 1A and 1B. The methods may be implemented using exemplarily a system embodiment shown in FIG. 1D. The payment for the transaction is performed using a mobile device (150 in FIG. 1D) having an EW App (152 in FIG. 1D), and the transaction is authorized by a POS terminal (154 in FIG. 1D). The POS terminal may have one or more peripheral devices (160 in FIG. 1D) associated therewith. Such peripheral devices may include a signature capture device, a check reader, a driver license or check imager, a biometrics reader, etc. The mobile device is referred to hereinafter as a “cell phone” for simplicity. An EW-TS (156 in FIG. 1D) connects on one hand to the EW App and on another hand to the POS terminal (and through it to a peripheral device, if present) to request card authorization from card issuers or consumer banks payment instrument issuers. The flow follows a consumer who proceeds to a merchant checkout after purchasing one or more items in a shopping session in a store, on the phone, or online The consumer may use a traditional payment option (i.e. cash, credit or debit card, or check), or may use the EW to pay for the purchase. In the scenario shown in FIG. 1A, it is assumed that the consumer is enrolled (registered) in an EW program. In the event the consumer is registered, the consumer is asked whether he/she wishes to pay by phone (i.e. use the EW) in step 122. If NO, then a traditional payment option is chosen to pay for the transaction in step 124 and the transaction follows a traditional payment flow in step 126. If YES in step 122, then in a first flow track, the consumer opens the EW App, logs into the EW-TS with his/her EW and PIN sequence and enters the sales amount into the cell phone or accepts a sales amount sent by the EW-TS in step 128. The EW App selects a merchant register or acts as a register in step 130. In step 132, the EW-TS accepts the login and simultaneously, the EW App identifies the POS terminal (if there is more than one such terminal and if the identification was not done already in step 130) to the EW-TS. The identification may be done by scanning an ID feature such as a QC code, by entering a POS terminal number or by other identification means. In some embodiments, the EW App enters or confirms a partial (e.g. in a split tender scenario or in a restaurant/bar) or full sales amount in step 134. Alternatively, the EW App may be used itself as a “register”, thus, the EW sends the sales amount to the POS terminal through the EW-TS, while the POS terminal logs into the EW-TS, matches the request and continues the flow from step 136, see below

In a second (and optional) flow track after a pay-by-phone (PbP) option is chosen in step 122, the POS terminal is chosen for payment and the cell phone number, password (PIN) and sales amount are entered into it in step 138. This track can be used if the consumer does not have an EW APP but has only his/her cell phone number and password. In this track, a transaction using the POS terminal may speed up the EW payment process between step 128 and step 136 (by having the EW log into the EW-TS and enter PIN in step 128 and by leaving steps 130-134 to be performed by the POS terminal). The POS terminal sends the data entered to the EW-TS in step 140. The EW-TS matches credentials in step 136 and allows (if matched) card data to the POS terminal in step 142. The POS terminal then proceeds to authorization (approval or decline) in step 144 and sends an authorization message to the effect to the EW-TS in step 146, which in turn updates the EW App in step 148.

The major advantages of the method disclosed above are: the transaction is effected without a need for authentication through a gateway, the transaction cost is reduced, and all registered payment instruments are transacted with and by a single payment device - the POS terminal. Consequently, reporting, consolidation and management are easy and convenient. In addition, a merchant can have now a pay-by-phone solution with only a POS terminal, independent of his/her POS system, electronic cash register (ECR) or PC-based register. No changes are required to an existing merchant ECR or PC-based system to work with the EW App.

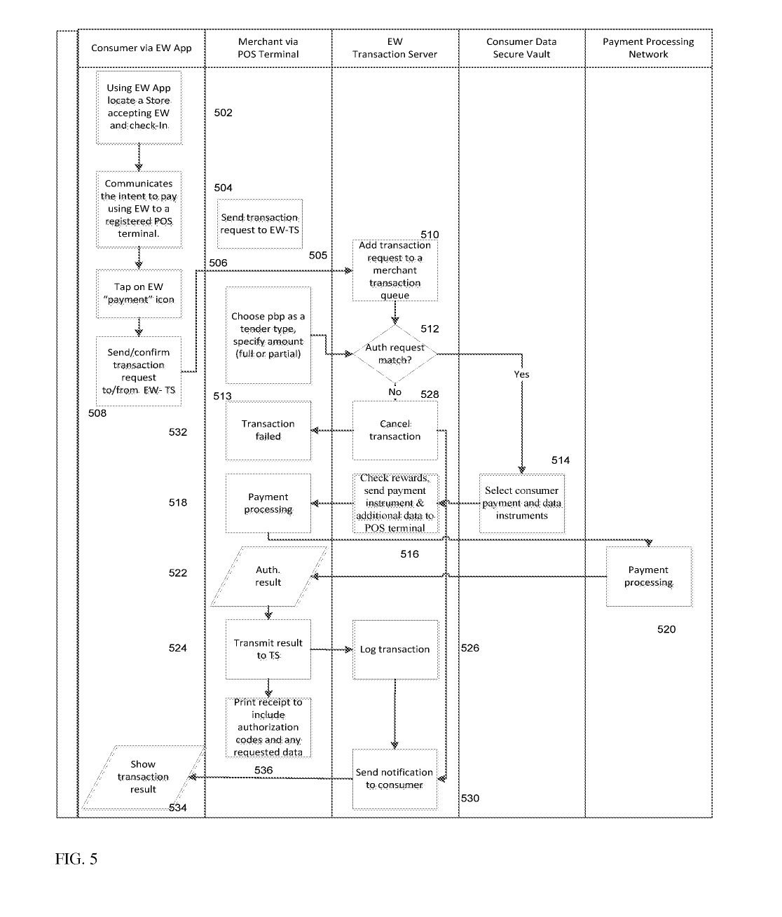

FIG. 2 shows in a flow chart the exemplary use of a mobile device (e.g. a cell phone) which includes an EW for a “pay-at-the-table” (e.g. in a restaurant) transaction with counter-top or wireless POS terminal authorization. The transaction is between a consumer and a waiter carrying a POS terminal. It is assumed that the consumer is enrolled in an EW program. The transaction begins with a restaurant bill presented by the waiter to the consumer. As in the method of FIG. 1, the consumer is asked whether he/she wishes to pay the bill by phone in step 202. If NO, then a traditional payment option is chosen to pay the bill in step 204 and the transaction follows a traditional payment flow in step 206. If YES in step 202, the POS terminal connects to the EW-TS in step 208 and sends a payment request with all relevant payment data (such as table number, number of guests, etc,). Alternatively, the consumer opens the EW App, enters a PIN and confirms a bill amount received from the POS terminal. The request is authenticated by the EW-TS in step 210. The bill amount plus any pre-calculated tip, is entered by the consumer into the EW App in step 212. Optionally, additional identifying details (e.g. required by the location) such as table number, number of diners, etc., are provided in step 214 and a question on whether these details plus a tip should be added is posed in step 216. If YES, the details and/or the tip are added to the bill and the total transaction amount is entered into the EW App in step 218, and the final amount is submitted by clicking the EW App “Pay” button in step 220. If NO in step 216, the process goes directly to step 220. A message is then sent from the EW-TS to the POS terminal, and the payment results are shown on the POS terminal and EW App in step 222. The transaction flow then continues as outlined in FIG. 5, from step 516.

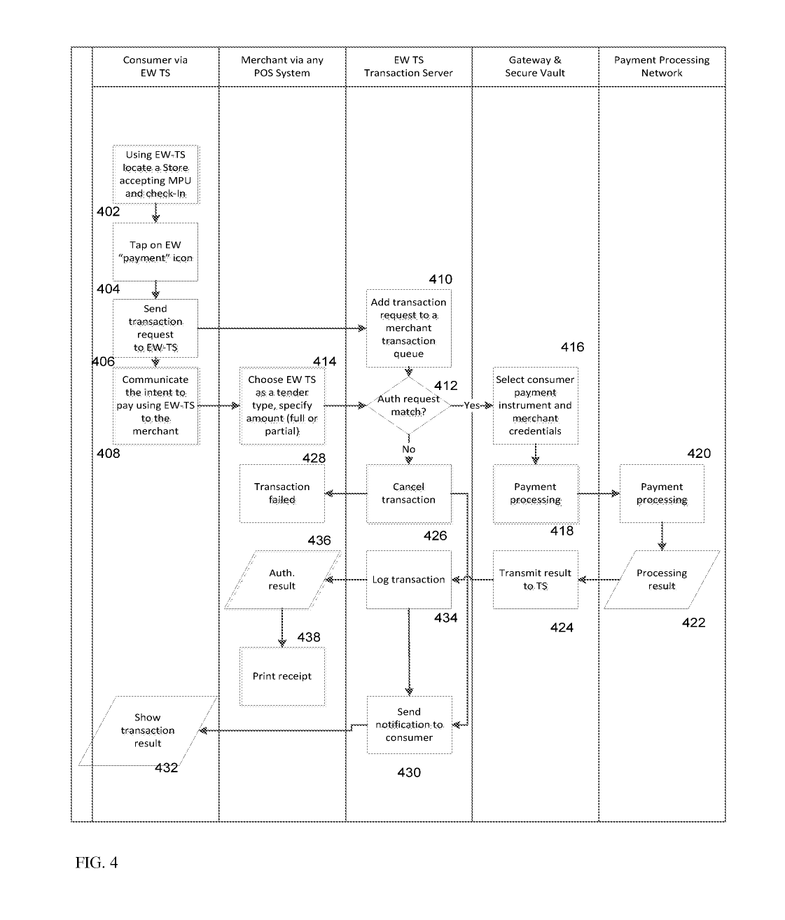

FIG. 3 shows in a flow chart an exemplary consumer enrollment procedure using a cell phone and a POS terminal. The procedure occurs exemplarily in a store and starts with the consumer using a credit card, debit card, or a check (via an attached peripheral device that scans the MICR or obtains a check image) to pay for a transaction in step 302. The consumer is asked whether he/she wishes to enroll in a mobile EW program in step 304. The EW program allows the consumer to conduct future transactions using his/her cell phone's EW App. If NO, then either that the consumer is already enrolled and may continue exemplarily as in the flow of FIG. 1, or he/she is not interested in enrolling, in which case the transaction may follow the traditional credit/debit card or check route. If YES, the merchant enters via the POS terminal enrollment data in addition to the type of payment instrument in step 306. The enrollment data may include for example a cell-phone number and a PIN, an image, a real signature, an electronic signature, etc. The merchant (via the POS terminal) then sends the data to the EW-TS in step 308. The EW-TS searches an associated database for matching data in step 310. The search asks whether this is a new enrollment in step 312. If this is a new enrolment (YES), the consumer enrollment data (exemplarily cell-phone number and PIN) are stored in a consumer data secure vault, i.e. an EW-TS DB in a PCI DSS location or in a stand alone PCI DSS DB (158 in FIG. 1D) in step 314. The EW-TS notifies the POS terminal that the enrollment is complete in step 316, an enrollment result is provided to the merchant via the POS terminal in step 318 and the process continues to step 320, (which minors step 124 in FIG. 1C), after which the transaction continues exemplarily as in FIG. 1C. If NO in step 312, the EW-TS notifies the POS terminal in step 316. The transaction then continues in step 322 with a traditional payment instrument process to card issuer approval and conclusion of the transaction. The card is now enrolled into the EW.

Note that some of the additional payment data such an image, a real signature, an electronic signature, etc. can complement or enhance a traditional POS terminal transaction without using any EW payment instrument for example by sending a signature image to a POS terminal transaction before or after an authorization

FIGS. 4 and 5 illustrate further the differences between known methods and the methods disclosed herein. Specifically, they emphasize the difference between an EW App that uses a transaction gateway to authorize a transaction through an Internet server after a request for an EW-TS (as currently known and done), and the use of a POS terminal to authorize the transaction after receiving card data from an EW-TS as taught herein.

FIG. 4 shows in a flow chart a known exemplary transaction flow between a mobile EW and a POS system (such as an ECR, a PC-based register, etc., but not a POS terminal) and using an Internet based transaction gateway. In a first option, the payment is through an ECR or a PC-based register. The consumer contacts the EW-TS with his/her cell phone, locates an EW-accepting store and checks-in (opens the EW App and logs into the EW-TS) in step 402. A regular EW transaction as described exemplarily in FIG. 1A then follows. The consumer taps on the EW “Payment” icon in step 404, sends a transaction request through the EW App to the EW-TS in step 406, and communicates his/her intent to pay by phone using his EW App to the merchant in step 408. The EW-TS server adds the transaction request to a merchant transaction queue in step 410. Alternatively, in a second option from step 408 with either merchant or consumer operated POS terminals, in step 414 either party chooses pay-by-phone as a tender type after the amount has been entered or displayed. The EW-TS then checks if the request from the merchant location matches the EW request in step 412. If YES, the request is sent via a transaction gateway to a gateway-secure vault DB for selection of a consumer payment instrument (such as a stored credit card) and merchant credentials in step 416. The payment is then processed through the transaction gateway with the EW-TS in step 418, and then processed by a payment processing network (162 in FIG. 1D) in step 420. A processing result is obtained in step 422. The processing result is transmitted via the transaction gateway to the EW-TS in step 424. The EW-TS logs the transaction in step 434 and provides the authorization to the merchant POS system in step 436. The terminal then prints a receipt in step 438.

If in the check of step 412 the answer is NO (the authorization request from the EW-TS does not match between the POS system and the EW App), the EW-TS cancels the transaction in step 426 and notifies the merchant that the transaction failed in step 428. The EW-TS also notifies the consumer about the cancellation in step 430 and the consumer sees this notification on his EW App in step 432.

Note that a common aspect of the two flows shown in FIG. 4 is that both require use of a transaction gateway.

FIG. 5 shows an exemplary payment processing using a POS terminal according to a method disclosed herein. In a first option, the payment is through an ECR or a PC-based register. The consumer contacts the EW-TS with his cell phone, locates an EW-accepting store and checks-in (opens the EW App and logs into the EW-TS) in step 502. A regular EW transaction as described exemplarily in FIG. 1A then follows. The consumer taps on the EW “Payment” icon in step 504 communicates the intent to pay using EW to a registered merchant POS terminal and taps on the EW “Payment” icon in step 506, and sends a transaction request to the EW-TS in step 508. Alternatively, the POS terminal sends a specific transaction request with the specific amount to the EW-TS in step 505. In this case, in step 506 the consumer confirms a transaction request from the EW-TS. In both options, the consumer then confirms his/her password to accept a sales amount in step 508. The EW-TS server adds the transaction request to a merchant transaction queue in step 510. Alternatively, in a second option, the merchant via the POS terminal chooses pay-by-phone as a tender type and specifies the sales amount in step 513. The EW-TS then checks if a request for authorization from the merchant location matches the EW transaction request in step 512. If the answer to check 512 is YES, then in step 514 a consumer payment instrument choice is selected from a secure vault directly by the EW-TS and returned to the POS terminal for card issuer processing. Advantageously, the payment instrument is not sent to a transaction gateway. The EW-TS verifies any reward eligibility, discount or promotion before retuning a final authorization amount to the POS terminal in step 516. Note that in step 516 the EW-TS check for reward eligibility is driven only by EW-App and POS terminal purchases. The EW-TS checks consumer rewards eligibility in order to provide a discount, free purchuse, prizes, gifts etc while conducting a payment from the EW to the EW-TS and/or to the POS terminal

Any relevant data such as a signature or special coupons are also sent through the EW-TS to the POS terminal in step 516, and the payment is processed in the POS terminal in step 518. The payment is then transmitted to the payment processing network for further processing in step 520. The authorization result is transmitted to the merchant POS terminal in step 522. After obtaining the processing result from a card issuer, a debit network or a bank (if a checking account is used), the POS terminal sends the transaction result to the EW-TS in step 524 and prints a receipt with authorization codes and any relevant attachment such as signature capture image in step 536. The EW-TS logs the transaction in step 526 and sends notification to the consumer that the transaction is completed and logged in step 530. The notification is showed to the consumer on his EW App in step 534.

If in the check of step 512 the answer is NO, the EW-TS cancels the transaction in step 528 and notifies the merchant that the transaction failed in step 532. The EW-TS also sends a notification to the consumer about the cancellation in step 530 and the consumer sees this notification on his EW App in step 534. Note that throughout the transaction process there is no use of a transaction gateway.

While this disclosure describes a limited number of embodiments, it will be appreciated that many variations, modifications and other applications of such embodiments may be made. In general, the disclosure is to be understood as not limited by the specific embodiments described herein, but only by the scope of the appended claims.

What is claimed is:

1. A method for conducting a transaction between an electronic wallet (EW) and a merchant electronic point-of sale (POS) terminal, the EW associated with an EW application (EW App) included in a mobile device, the method comprising the steps of: by an electronic wallet terminal server (EW-TS):
a) receiving a transaction request from a particular EW and from an authenticated POS terminal for a sales amount;
b) sending respective EW-associated payment instrument data back to the POS terminal; and
c) receiving from the POS terminal authorization approval for the transaction, wherein the authorization approval is received directly from the POS terminal without use of a transaction gateway.

2. The method of claim 1, wherein the particular EW is included in a cell-phone and wherein the transaction request from the POS terminal includes an EW personal identification number and a cell-phone number.

3. The method of claim 1, wherein wherein the transaction is a pay-by-phone transaction requiring the EW be be enrolled in a mobile EW program and wherein the step of receiving a transaction request includes, by the POS terminal, enrolling the EW in a mobile EW program.

4. The method of claim 1, wherein the transaction involves a restaurant bill and wherein the sales amount is entered by the EW and includes two partial sales amounts requesting a single authorization approval.

5. The method of claim 1, wherein the payment instrument is a credit or debit card.

6. The method of claim 1, wherein the payment instrument is a check.

7. The method of claim 1, wherein the step of receiving a transaction request from a particular EW includes receiving a request for a signature file and wherein the step of sending respective EW-associated payment instrument data back to the POS terminal includes sending the signature file to the POS terminal in real time.

8. The method of claim 1, wherein the step of sending respective EW-associated payment instrument data is preceded by the step of checking for respective EW-associated reward, discount or promotion eligibility and if such eligibility is found, sending respective EW-associated reward, discount or promotion data together with the payment instrument data back to the POS terminal.

9. A method for conducting a transaction between an electronic wallet (EW) and a merchant electronic point-of sale (POS) terminal, the EW associated with an EW application (EW App) included in a mobile device, the method comprising the steps of: by an electronic wallet terminal server (EW-TS):
a) receiving a transaction request with a sales amount, cell phone number and password from a POS terminal;
b) sending a payment instrument to the POS terminal; and
c) receiving from the POS terminal authorization approval for the transaction, wherein the authorization approval is received directly from the POS terminal without use of a transaction gateway.

10. The method of claim 9, wherein wherein the transaction is a pay-by-phone transaction requiring the EW be be enrolled in a mobile EW program and wherein the step of receiving a transaction request is preceded by the step of, by the POS terminal, enrolling the EW in a mobile EW program.

11. The method of claim 9, wherein wherein the transaction is a pay-by-phone transaction requiring the EW to be enrolled in a mobile EW program, and wherein the step of receiving a transaction request is preceded by the step of, by the POS terminal, enrolling the EW in a mobile EW program.

12. The method of claim 10, wherein the transaction involves a restaurant bill and wherein the sales amount is entered by the EW and includes two partial sales amounts requesting a single authorization approval.

13. The method of claim 9, wherein the payment instrument is a credit or debit card.

14. The method of claim 9, wherein the payment instrument is a check.

15. The method of claim 9, wherein the step of sending a selected payment instrument to the POS terminal includes sending the selected payment instrument together with consumer payment data.

16. The method of claim 15, wherein the payment data is selected from the group consisting of a real signature, an electronic signature, a biometric signature, a photograph and a combination thereof.

17. The method of claim 9, wherein wherein the transaction is a pay-by-phone transaction requiring the EW be be enrolled in a mobile EW program and wherein the step of receiving a transaction request is preceded by the step of, by the POS terminal, enrolling the EW in a mobile EW program.

18. The method of claim 9, wherein the step of receiving a transaction request from a particular EW includes receiving a request for a signature file and wherein the step of sending respective EW-associated payment instrument data back to the POS terminal includes sending the signature file to the POS terminal in real time.

19. The method of claim 18, wherein the step of sending respective EW-associated payment instrument data is preceded by the step of checking for respective EW-associated reward, discount or promotion eligibility and if such eligibility is found, sending respective EW-associated reward, discount or promotion data together with the payment instrument data back to the POS terminal.

20. A method for conducting a transaction between an electronic wallet (EW) and a merchant electronic point-of sale (POS) terminal, the EW associated with an EW application (EW App) included in a mobile device, the method comprising the steps of: by the POS terminal:
a) sending a transaction request obtained from a particular EW to an electronic wallet terminal server (EW-TS), the transaction request including a sales amount and a request for supporting payment instrument data;
b) receiving from the EW-TS respective EW-associated payment instrument; and
c) authorizing the transaction, wherein the authorization is provided directly from the POS terminal to the EW-TS without use of a transaction gateway.
